(19) United States
(12) Patent Application Publication
(10) Pub. No.: US 2019/0286639 A1
(43) Pub. Date: Sep. 19, 2019

(54) CLUSTERING PROGRAM, CLUSTERING METHOD, AND CLUSTERING APPARATUS

(71) Applicant: FUJITSU LIMITED, Kawasaki-shi (JP)

(72) Inventors: Yuji Mizobuchi, Kawasaki (JP); Kuniharu Takayama, Tama (JP)

(73) Assignee: FUJITSU LIMITED, Kawasaki-shi (JP)

(21) Appl. No.: 16/351,777

(22) Filed: Mar. 13, 2019

(30) Foreign Application Priority Data
Mar. 14, 2018 (JP) 2018-047064

(51) Int. Cl. G06F 16/28

(52) U.S. Cl. CPC G06F 16/285; G06F 16/288

(57) ABSTRACT

A clustering method performed by a computer for clustering on a plurality of elements given relationship data concerning the relationship between some elements, the method includes: calculating relevance between the plurality of elements by using the attributes of the plurality of elements; calculating a threshold value for identifying link attributes between the elements in accordance with the relevance and the relationship data concerning each set of elements given the relationship data; determining link types between the plurality of elements in accordance with the threshold value; and performing clustering in accordance with the result of determination.

### CROSS-REFERENCE TO RELATED APPLICATION

This application is based upon and claims the benefit of priority of the prior Japanese Patent Application No. 2018-47064, filed on Mar. 14, 2018, the entire contents of which are incorporated herein by reference.

### FIELD

The embodiments discussed herein are related to a clustering program, a clustering method, and a clustering apparatus.

### BACKGROUND

Document clustering is performed to efficiently gather information from similar documents such as news documents or make multifaceted information analysis of the cause of and solution to an incident. For example, the k-means clustering method is used to satisfy the constraints of a label named “must-link” and of a label named “cannot-link.” The “must-link” label is assigned to documents belonging to the same class. The “cannot-link” label is assigned to documents belonging to different classes.

In recent years, there is a clustering method based on supervised learning. For example, there is a method to perform clustering by the k-means method after learning the weight of each feature in a multidimensional space through the use of labels named “must-link” and “cannot-link.” There is another method to perform hierarchical clustering in a multidimensional space while adjusting the weight of each dimension so as to match prepared learning data (must-link, cannot-link), and repeat such hierarchical clustering until the error rate converges. There is still another method to use a determination model, such as a regression model, in order to learn a specific height (distance) of a dendrogram of agglomerative clustering at which clustering is to be performed, estimate whether documents relate to each other, and classify similar documents into the same cluster in accordance with the result of estimation. Examples of the related art include Japanese Laid-open Patent Publication No. 2013-134752, Japanese Laid-open Patent Publication No. 2012-243214, and International Publication Pamphlet No. WO 2013/01893.

However, when a plurality of documents are to be clustered and similar documents are linked at multiple levels, the above-described related arts may cause the contents of the documents to change during clustering. Thus, the documents having completely different contents may belong to the same cluster. Therefore, proper results may not be obtained by clustering.

For example, the similarity between documents may be relative such that documents similar in a certain point of view (topic) may be dissimilar in another point of view. However, the above-described related arts do not attach such information to human-made labels. Therefore, the similarity based on different points of view is learned from learning data. Consequently, a similarity determination process continuously joins corresponding sides by ignoring the boundary between different points of view.

FIG. 9 is a diagram illustrating issues involved in common document clustering. The example of FIG. 9 depicts a case where clustering is performed based on the multiplicity of words in documents. As illustrated in FIG. 9, when similar documents are linked at multiple levels, the contents of the documents may change in the process. Thus, the documents having completely different contents may belong to the same cluster. For example, as regards neighboring documents (1) to (6) in FIG. 9, the similarity may be as high as “0.667” due to the difference of only one word. Therefore, all such documents may belong to the same cluster. However, documents (1) and (6) have completely different contents so that the similarity may be as low as “0.111.” Therefore, it is preferable that documents (1) and (6) be classified into different clusters. Likewise, it is difficult to say that documents (1) and (5) are similar to each other, and that documents (2) and (6) are similar to each other. Therefore, it is preferable that documents (1) and (5) be classified into different clusters, and that documents (2) and (6) be classified into different clusters. The meanings of example sentences (1) to (5) will be described later with reference to FIG. 3. The meaning of example sentence (6) is “Next month, with Hanako, go for making by Plan-A.)”

### SUMMARY

According to an aspect of the embodiments, a clustering method performed by a computer for clustering on a plurality of elements given relationship data concerning the relationship between some elements, the method includes: calculating relevance between the plurality of elements by using the attributes of the plurality of elements; calculating a threshold value for identifying link attributes between the elements in accordance with the relevance and the relationship data concerning each set of elements given the relationship data; determining link types between the plurality of elements in accordance with the threshold value; and performing clustering in accordance with the result of determination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a clustering device according to a first embodiment;

FIG. 2 is a functional block diagram illustrating a functional configuration of a clustering device according to the first embodiment;

FIG. 3 is a diagram illustrating an example of information to be stored in a learning data database (DB);

FIG. 4 is a diagram illustrating extraction of relationship between documents;

FIG. 5 is a diagram illustrating estimation of relationship between documents;

FIG. 6 is a diagram illustrating a result of clustering;

FIG. 7 is a flowchart illustrating steps of a clustering process;

FIG. 8 is a diagram illustrating an exemplary hardware configuration; and

FIG. 9 is a diagram illustrating issues involved in common document clustering.

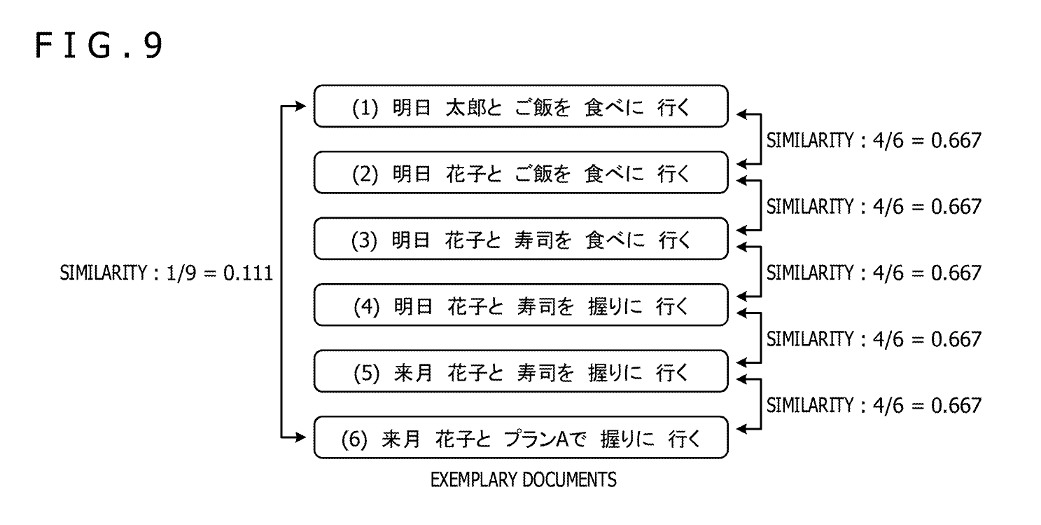

### DESCRIPTION OF EMBODIMENTS

Embodiments of a clustering program, a clustering method, and a clustering device that are disclosed in the present application will now be described in detail with reference to the accompanying drawings. It is to be noted that the following embodiments do not limit the clustering program, the clustering method, and the clustering device that are disclosed in the present technology. It is also to be noted that the embodiments may be combined as appropriate within a consistent range.

### First Embodiment

[Overall Configuration]

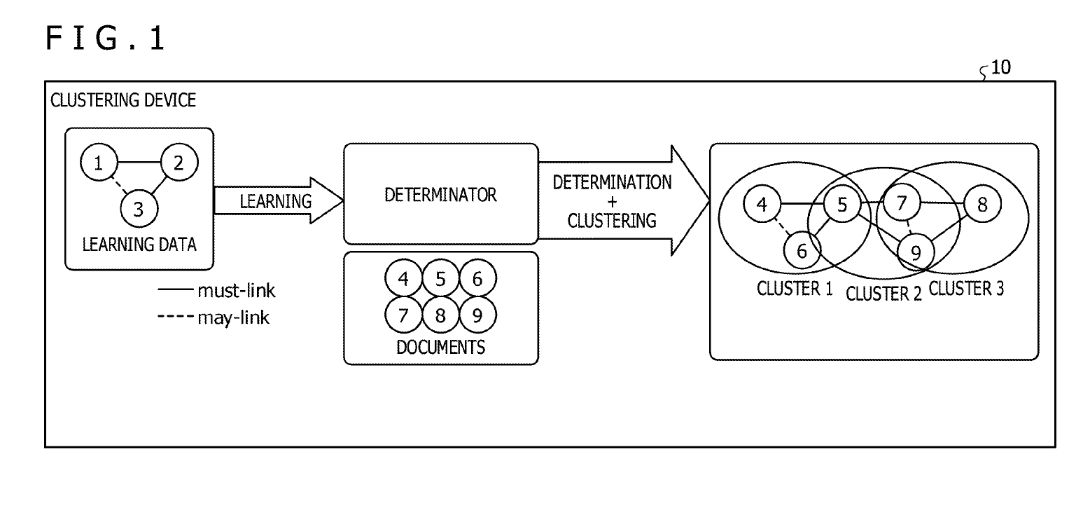

FIG. 1 is a diagram illustrating a clustering device according to a first embodiment. As illustrated in FIG. 1, a clustering device 10 performs a series of processing steps for document clustering, that is, learns a label by reading learning data, and generates clusters by classifying classification target documents with a determinator.

For example, the clustering device 10 reads learning data including a document to which a “must-link” label is attached by a user or the like. Then, in accordance with the “must-link” label existing in the learning data, the clustering device 10 extracts a “may-link” label indicative of the relationship between nodes that are not directly linked by the “must-link” label but are linked by the “must-link” label through a third node (document). When, for example, the “must-link” label is individually attached to documents 1 and 2, and documents 2 and 3, the clustering device 10 extracts a “may-link” label because a certain degree of similarity exists between documents 1 and 3 although the relationship may not be so strong as the “must-link” label and a designated link between documents 1 and 3 is not “must-link.”

Subsequently, the clustering device 10 classifies nodes satisfying conditions 1 and 2 into the same cluster by using a relationship determinator learned by “must-link” and “may-link.” Condition 1 is that nodes in a cluster are linked by at least one “must-link.” Condition 2 is that the nodes are linked to all the other nodes in the cluster by “may-link” or “must-link.”

For example, the clustering device 10 determines that clusters linked by “must-link,” which is given by an actual human, are complete graphs including “may-link” sides, which are not given by a human, and considered to be clusters based on a certain or particular point of view (context or topic). The clustering device 10 also determines that portions not forming a complete graph through “may-link” represent different points of view, and that checking whether a complete graph including “may-link” is equivalent to a search for a break in the points of view.

Consequently, the clustering device 10 determines the product set of a set of clusters that are hierarchized by the single linkage method and creatable with a value not greater than a threshold value learned by “must-link” and a set of clusters that are among cluster candidates permitting duplication and form a complete graph with a value not greater than the threshold value learned by “may-link.” Therefore, the clustering device 10 is able to properly perform clustering on a plurality of documents.

[Functional Configuration]

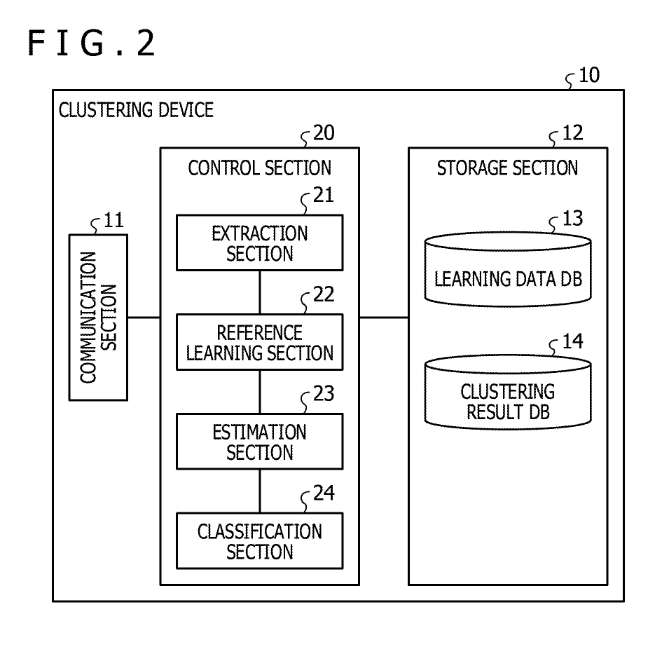

FIG. 2 is a functional block diagram illustrating a functional configuration of a clustering device according to the first embodiment. As illustrated in FIG. 2, the clustering device 10 includes a communication section 11, a storage section 12, and a control section 20.

The communication section 11 is a processing section for controlling communication between other devices. For example, the communication section 11 receives a processing start instruction and learning data from an administrator terminal, and transmits the result of clustering to a designated terminal.

The storage section 12 is an example of a storage device for storing a program and data. The storage section 12 is, for example, a memory or a hard disk. The storage section 12 includes a learning data DB 13 and a clustering result DB 14.

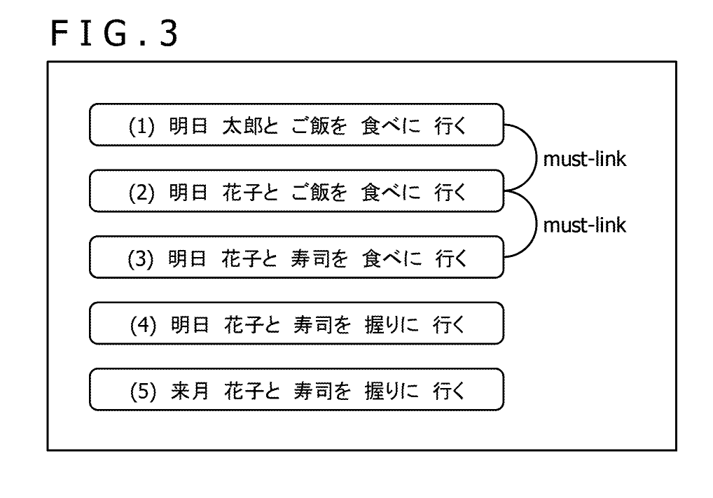

The learning data DB 13 is a database for storing a plurality of clustering target documents to which the “must-link” label is attached. For example, the learning data DB 13 stores documents that are learning data. FIG. 3 is a diagram illustrating an example of information to be stored in a learning data DB. As illustrated in FIG. 3, the learning data DB 13 stores five documents, documents (1) to (5).

Document (1) is “ [symbol] (Tomorrow, with Taro, go for having meal.)” Document (2) is “ [symbol] (Tomorrow, with Hanako, go for having meal.)” Document (3) is “ [symbol] (Tomorrow, with Hanako, go for having sushi.)” Document (4) is “ [symbol] (Tomorrow, with Hanako, go for making sushi.)” Document (5) is “ [symbol] (Next month, with Hanako, go for making sushi.)”

Referring to FIG. 3, “must-link” is set between documents (1) and (2), and “must-link” is set between documents (2) and (3). The number of documents and the setup of labels are merely examples and may be changed as desired. The information to be stored may be a document itself or a document separated into morphemes by making morphological analysis of the document.

The clustering result DB 14 is a database for storing the result of clustering. For example, the clustering result DB 14 stores a clustered document generated by the later-described control section 20. Details are omitted and will be given later.

The control section 20 is a processing section for governing or controlling the whole clustering device 10. The control section 20 is, for example, a processor. The control section 20 includes an extraction section 21, a reference learning section 22, an estimation section 23, and a classification section 24. The extraction section 21, the reference learning section 22, the estimation section 23, and the classification section 24 are examples of electronic circuits included in the processor or examples of processes executed by the processor. The extraction section 21 is an example of a first calculation section, the reference learning section 22 is an example of a second calculation section, the estimation section 23 is an example of a determination section, and the classification section 24 is an example of a classification section.

The extraction section 21 is a processing section for extracting the relationship between individual documents from inputted documents. For example, the extraction section 21 reads a plurality of documents stored in the learning data DB 13, extracts preset “must-link,” and extracts “may-link” by using “must-link.”

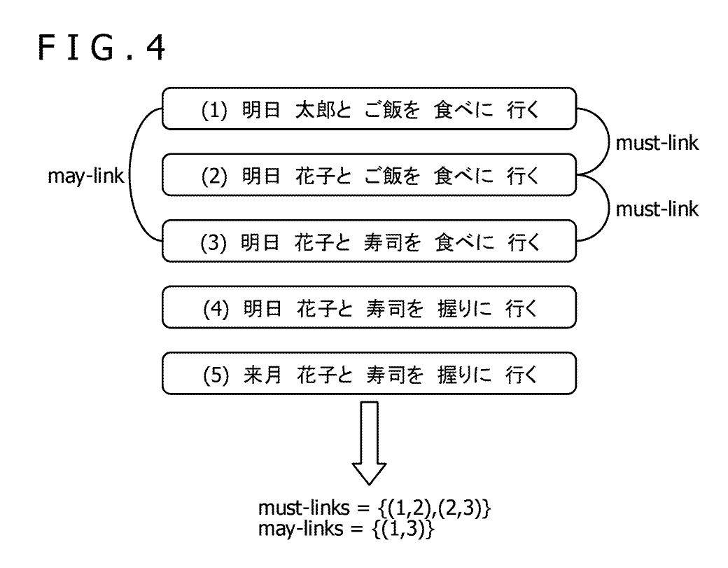

FIG. 4 is a diagram illustrating extraction of relationship between documents. As illustrated in FIG. 4, the extraction section 21 extracts “must-link” set or given between documents (1) and (2), and extracts “must-link” set or given between documents (2) and (3). Documents (1) and (3) are not directly linked by “must-link,” but are linked by “must-link” through document (2). Therefore, the extraction section 21 extracts “may-link” between documents (1) and (3).

The extraction section 21 outputs, to the reference learning section 22, “must-links={(1,2), (2,3)},” which is the result of “must-link” extraction, and “may-links={(1,3)},” which is the result of “may-link” extraction.

The reference learning section 22 is a processing section that calculates the similarity between documents, as relevance, by using the result of extraction by the extraction section 21, and learns the reference for determining the relationship between the documents. For example, the reference learning section 22 calculates a threshold value determinable as “must-link” in accordance with a “must-link” extraction result inputted from the extraction section 21, and calculates a threshold value determinable as “may-link” in accordance with a “may-link” extraction result inputted from the extraction section 21. The reference learning section 22 outputs each calculated threshold value to the estimation section 23.

Referring to the above example, as regards documents (1) and (2), which are “must-link” documents, the reference learning section 22 identifies six words (or six groups of words) in documents (1) and (2), “ [symbol] (Tomorrow), [symbol] (with Taro), [symbol] (meal), [symbol] (for having), [symbol] (go)” and “ [symbol] (with Hanako).” The reason is that “ [symbol] (Tomorrow), [symbol] (with Taro), [symbol] (meal), [symbol] (for having), [symbol] (go)” are obtained by subjecting document (1) to a well-known analysis, such as morphological analysis and word extraction, and that “ [symbol] (Tomorrow), [symbol] (with Hanako), [symbol] (meal), [symbol] (for having), [symbol] (go)” are similarly obtained from document (2). Subsequently, as four out of six words (or six groups of words), “ [symbol] (Tomorrow), [symbol] (meal), [symbol] (for having), [symbol] (go),” are used in common in documents (1) and (2), the reference learning section 22 performs calculations to determine the similarity to be “4/6≈0.667.”

Similarly, as regards documents (2) and (3), which are “must-link” documents, the reference learning section 22 identifies six words (or six groups of words) in documents (2) and (3), “ [symbol] (Tomorrow), [symbol] (with Hanako), [symbol] (meal), [symbol] (for having), [symbol] (go)” and “ [symbol] (sushi).” The reason is that “ [symbol] (Tomorrow), [symbol] (with Hanako), [symbol] (meal), [symbol] (for having), [symbol] (go)” are obtained from document (2), and that “ [symbol] (Tomorrow), [symbol] (with Hanako), [symbol] (sushi), [symbol] (for having), [symbol] (go)” are obtained from document (3). Subsequently, as four out of six words (or six groups of words), “ [symbol] (Tomorrow), [symbol] (with Hanako), [symbol] (for having), [symbol] (go),” are used in common in documents (2) and (3), the reference learning section 22 performs calculations to determine the similarity to be “4/6≈0.667.”

As the similarity between the documents for which “must-link” is set is “0.667” in the above two cases, the reference learning section 22 sets a “must-link” threshold value (reference value) to “0.667 (=c_must (=must-link-criteria)).” However, the threshold value may be set as desired. For example, if exactness is required in a case where the similarity between the documents for which “must-link” is set varies, relatively high similarity may be set as the threshold value. If, by contrast, exactness is not required in the above case, relatively low similarity or average similarity may be set as the threshold value.

As regards documents (1) and (3), which are “may-link” documents, the reference learning section 22 identifies seven words (or seven groups of words) in documents (1) and (3), “ [symbol] (Tomorrow), [symbol] (with Taro), [symbol] (meal), [symbol] (for having), [symbol] and [symbol] (with Hanako), [symbol] (sushi).” The reason is that “ [symbol] (Tomorrow), [symbol] (with Taro), [symbol] (meal), [symbol] (for having), [symbol] (go)” are obtained from document (1), and that “ [symbol] (Tomorrow), [symbol] (with Hanako), [symbol] (sushi), [symbol] (for having), [symbol] (go)” are obtained from document (3). Subsequently, as three out of seven words (or seven groups of words), “ [symbol] (Tomorrow), [symbol] (for having), [symbol] (go),” are used in common in documents (1) and (3), the reference learning section 22 performs calculations to determine the similarity to be “3/7≈0.439.”

As the similarity between the documents for which “may-link” is set is “0.439” and the “must-link” threshold value is “0.667,” the reference learning section 22 sets the “may-link” threshold value (reference value), which is “c_may (=may-link-criteria),” to “0.439≤c_may<0.667.” If a plurality of similarities exist between the documents for which “may-link” is set, a decision may be made by a method similar to the method for “must-link.”

The estimation section 23 is a processing section for estimating the relationship between documents by using determination criteria for the relationship between documents. For example, the estimation section 23 calculates the similarities between documents to which the “must-link” or “may-link” label is not attached, compares the calculated similarities with “c_must” and “c_may,” which are calculated by the reference learning section 22, and estimates “must-link” or “may-link” for unlabeled documents. The estimation section 23 then outputs the result of extraction by the extraction section 21 and the result of estimation to the classification section 24.

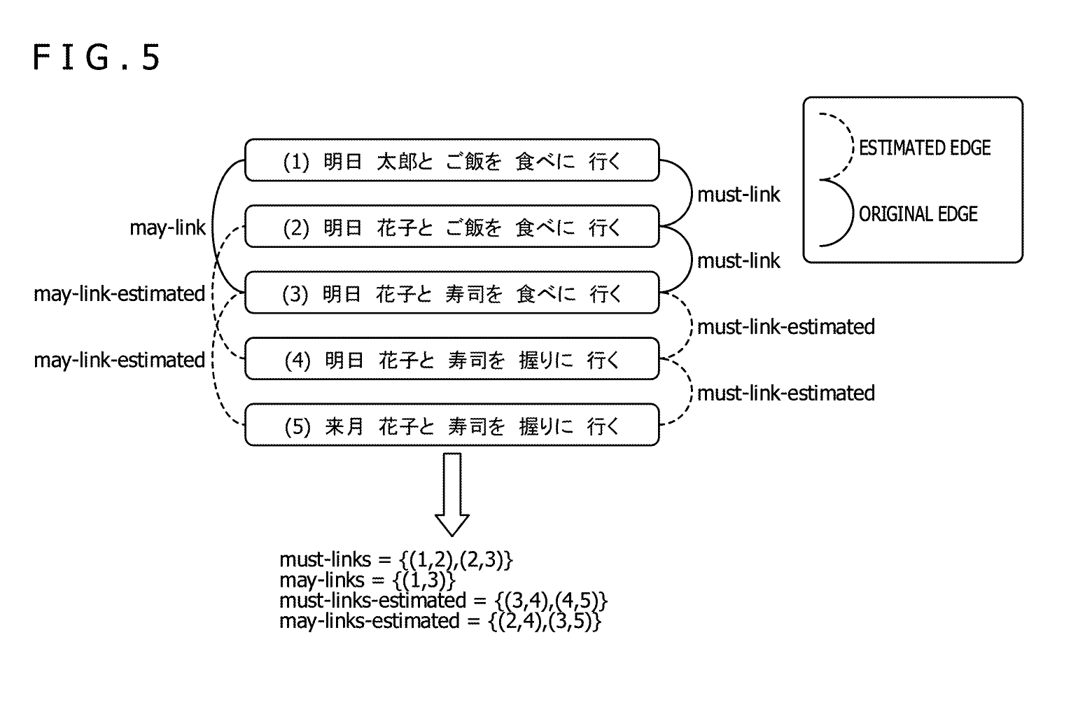

FIG. 5 is a diagram illustrating estimation of relationship between documents. As illustrated in FIG. 5, the estimation section 23 extracts, from documents (1) to (5), four pairs of unlabeled documents, documents (3) and (4), documents (4) and (5), documents (2) and (4), and documents (3) and (5). By a method similar to the above, the estimation section 23 performs calculations to determine the similarity between documents (3) and (4) to be “4/6≈0.667.” Subsequently, as the similarity between documents (3) and (4) is “0.667,” which is not smaller than “c_must=0.667,” the estimation section 23 assigns or estimates that the relationship between documents (3) and (4) is “must-link (must-link-estimated).”

Likewise, by a method similar to the above, the estimation section 23 performs calculations to determine the similarity between documents (4) and (5) to be “4/6≈0.667.” Subsequently, as the similarity between documents (4) and (5) is “0.667,” which is not smaller than “c_must=0.667,” the estimation section 23 estimates that the relationship between documents (4) and (5) is “must-link (must-link-estimated).”

Likewise, by a method similar to the above, the estimation section 23 performs calculations to determine the similarity between documents (2) and (4) to be “3/7≈0.439.” Subsequently, as the similarity between documents (2) and (4) is “0.439,” which is within the range of “0.439 c_may<0.667,” the estimation section 23 assigns or estimates that the relationship between documents (2) and (4) is “may-link (may-link-estimated).”

Likewise, by a method similar to the above, the estimation section 23 performs calculations to determine the similarity between documents (3) and (5) to be “3/7≈0.439.” Subsequently, as the similarity between documents (3) and (5) is “0.439,” which is within the range of “0.439 c_may<0.667,” the estimation section 23 estimates that the relationship between documents (3) and (5) is “may-link (may-link-estimated).”

Consequently, the estimation section 23 generates “must-link-estimated={(3,4),(4,5)},” which is the result of “must-link” estimation, and “may-link-estimated={(2,4),(3,5)}, which is the result of “may-link” estimation. The estimation section 23 then outputs, to the classification section 24, “must-links={(1,2),(2,3)},” “may-links={(1,3)},” “must-link-estimated={(3,4),(4,5)},” and “may-link-estimated={(2,4),(3,5)}.”

The classification section 24 is a processing section that clusters documents by using the result of extraction by the extraction section 21 and the result of estimation by the estimation section 23. For example, the classification section 24 extracts a subgraph. The subgraph turns into a complete graph when “may-link” or “may-link-estimated” is used within a range of linkage by “must-link” and “must-link-estimated.”

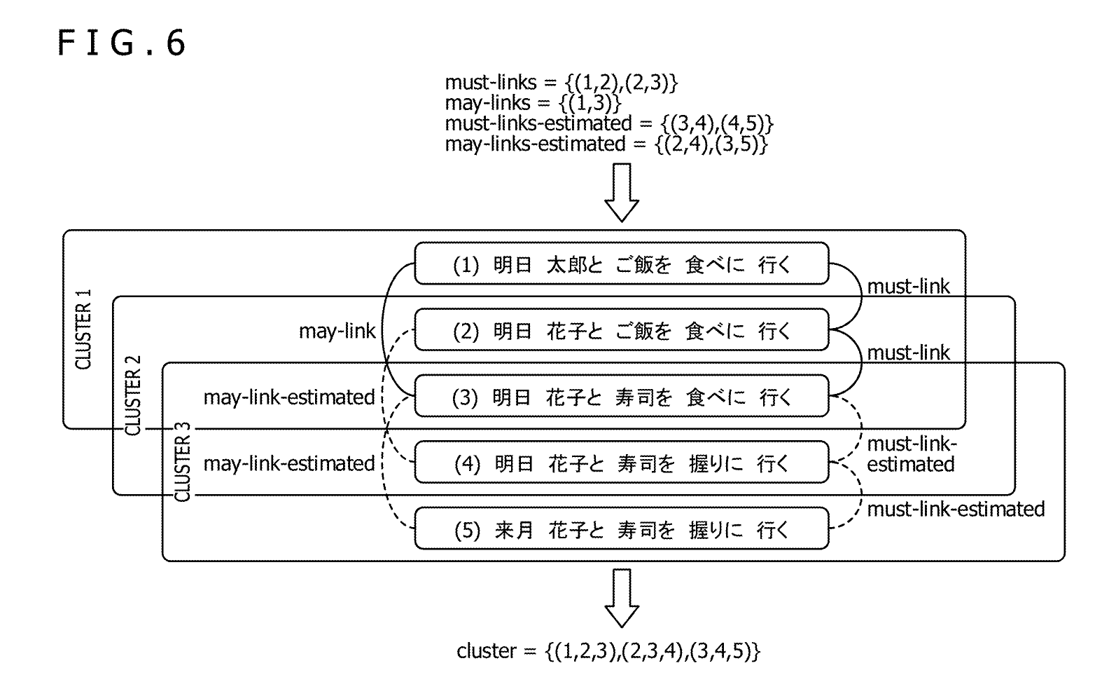

FIG. 6 is a diagram illustrating a result of clustering. As illustrated in FIG. 6, the classification section 24 determines that documents (1), (2), and (3) form a complete graph. The reason is that documents (1) and (2) are linked by “must-link,” and that documents (2) and (3) are linked by “must-link,” and further that documents (1) and (3) are linked by “may-link.” Therefore, the classification section 24 classifies documents (1), (2), and (3) into cluster 1.

Likewise, the classification section 24 determines that documents (2), (3), and (4) form a complete graph. The reason is that documents (2) and (3) are linked by “must-link,” and that documents (3) and (4) are linked by “must-link-estimated,” and further that documents (2) and (4) are linked by “may-link-estimated.” Therefore, the classification section 24 classifies documents (2), (3), and (4) into cluster 2.

Likewise, the classification section 24 determines that documents (3), (4), and (5) form a complete graph. The reason is that documents (3) and (4) are linked by “must-link-estimated,” and that documents (4) and (5) are linked by “must-link-estimated,” and further that documents (3) and (5) are linked by “may-link-estimated.” Therefore, the classification section 24 classifies documents (3), (4), and (5) into cluster 3.

Consequently, the classification section 24 generates “cluster={(1,2,3),(2,3,4),(3,4,5)},” which is the result of clustering, and stores the generated clustering result in the clustering result DB 14.

[Processing Flow]

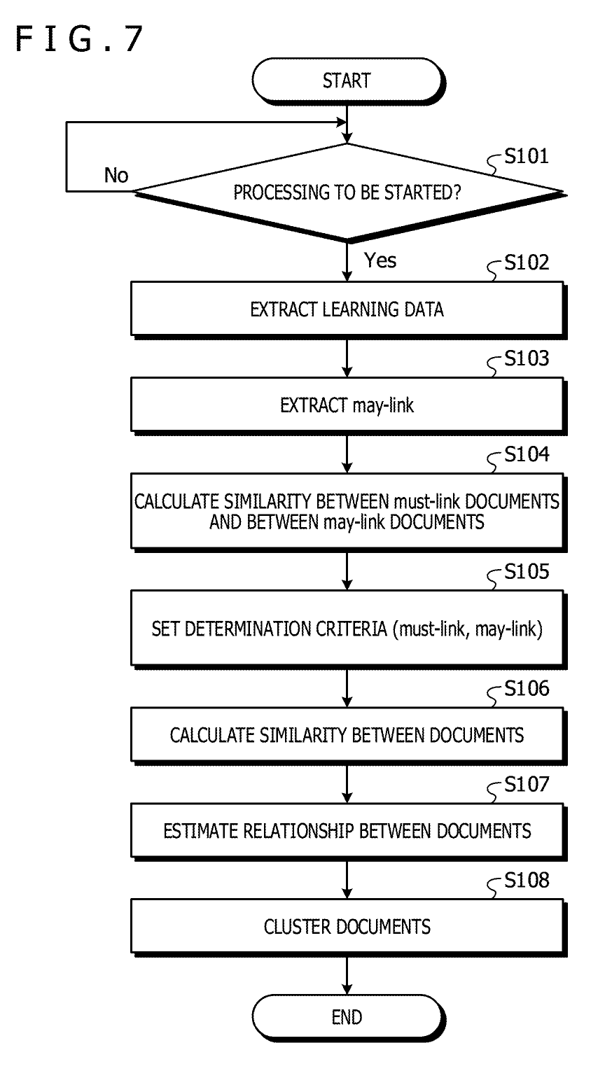

FIG. 7 is a flowchart illustrating steps of a clustering process. As illustrated in FIG. 7, when an instruction for starting the clustering process is issued (YES at step S101), the extraction section 21 extracts learning data, which includes documents, from the learning data DB 13 (step S102), and extracts “may-link” between documents by using “must-link,” which is set between the documents (step S103).

Next, the reference learning section 22 calculates the similarity between documents for which “must-link” is set and the similarity between documents for which “may-link” is set (step S104), and sets a determination criterion (threshold value) for each of “must-link” and “may-link” by using each of the calculated similarities (step S105).

Subsequently, the estimation section 23 calculates the similarity between documents that are learning data and unlabeled (step S106). The estimation section 23 then estimates the relationship between the documents by using the similarity between the unlabeled documents and each determination criterion (step S107). Subsequently, the classification section 24 extracts a subgraph by using the result of estimation, and clusters the documents. The subgraph turns into a complete graph when “may-link” or “may-link-estimated” is used within a range of linkage by “must-link” and “must-link-estimated” (step S108).

### Advantageous Effects

As described above, the clustering device 10 performs clustering on a plurality of documents, that is, a plurality of elements to which relationship data concerning the relationship between some elements is given. For example, the clustering device 10 calculates the relevance between a plurality of documents by using words in the documents, which are attributes of each of the plurality of documents. The clustering device 10 then calculates a threshold value for identifying the link attributes between the documents in accordance with the relevance and relationship data concerning each set of the documents to which the relationship data is given. Subsequently, based on the threshold value, the clustering device 10 identifies the link types between the plurality of documents, and performs clustering based on the result of determination.

Consequently, the clustering device 10 is able to increase the accuracy of clusters by preparing a plurality of references belonging to the clusters, and properly perform clustering on a plurality of elements.

### Second Embodiment

While an embodiment of the present technology has been described above, the present technology may be implemented by the foregoing embodiment, besides, by various other embodiments.

[Learning]

The first embodiment has been described with reference to an example in which a determination criterion for each link, such as “must-link” and “may-link,” is generated from learning target documents and used to perform clustering on the learning target documents. However, the present invention is not limited to such an example. For example, the clustering device 10 is also able to use learning target documents other than classification target documents, learn the determination criterion (threshold value) for each link, such as “must-link” and “may-link,” through, for example, machine learning, and then classify the classification target documents by using the result of learning.

Referring, for instance, to the above example, it is possible to learn the similarity between documents by performing, for example, machine learning or deep learning through the use of a supervised learning device while “must-link” and “may-link” are used as labels. For example, a feature space is learned without impairing the distance relationship between “must-link” and “may-link” and used to learn a model for predicting “must-link” and “may-link,” the learned model is then used to determine the relationship (must-link and may-link) between determination target documents, and clustering is performed in consideration of the relationship between the documents.

In the first embodiment, which has been described earlier, the data on the learning target documents may be separate from the data on the classification target documents. The above-mentioned similarity is an example of relevance. The method for similarity calculation is not limited to the method described in conjunction with the first embodiment. Various well-known methods may be adopted. The classification targets are not limited to documents. For example, an image may be used as a classification target as far as the type and feature value are extractable for determination purposes.

[System]

Information including processing steps, control steps, specific names, or various data or parameters indicated above or in drawings may be changed as desired unless otherwise stated.

Component elements of depicted various devices are like functional concepts, and need not be physically configured as depicted. For example, the details of dispersion and integration of the various devices are not limited to those depicted. The whole or part of the various devices may be configured by being subjected to functional or physical dispersion and integration in a desired unit depending, for instance, on various loads and uses. For example, a processing section for displaying items and a processing section for estimating preferences may be implemented by using separate housings. The whole or part of processing functions exercised by the various devices may be implemented by a central processing unit (CPU) and a program analyzed and executed by the CPU or implemented as hardware based on wired logic.

[Hardware]

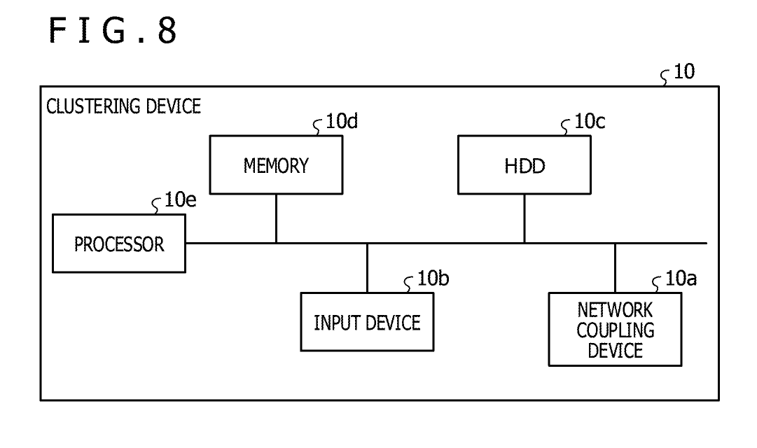

FIG. 8 is a diagram illustrating an exemplary hardware configuration. As illustrated in FIG. 8, the clustering device 10 includes a network coupling device 10a, an input device 10b, a hard disk drive (HDD) 10c, a memory 10d, and a processor 10e. The various sections depicted in FIG. 8 are intercoupled, for example, by a bus.

The network coupling device 10a is, for example, a network interface card and used to establish communication with another server. The input device 10b is, for instance, a mouse or a keyboard and used to receive, for example, various instructions from the user. The HDD 10c stores programs and DBs that exercise the functions depicted in FIG. 2.

The processor 10e performs a process for executing various functions described with reference, for example, to FIG. 2 by reading a program for executing a process similar to those of the processing sections depicted in FIG. 2 and loading the program into the memory 10d. This process executes the functions similar to that of the processing sections included in the clustering device 10. For example, the processor 10e reads, for instance, from the HDD 10c, a program having the functions similar to that of the extraction section 21, the reference learning section 22, the estimation section 23, and the classification section 24. The processor 10e then executes a process that executes the processing similar, for example, to that of the extraction section 21, the reference learning section 22, the estimation section 23, and the classification section 24.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium having stored therein a clustering program for causing a computer to execute a process for performing clustering, the process comprising:
calculating relevance between a plurality of elements that first relationship data are given between a part of the plurality of elements, based on attributes of the plurality of elements;
calculating at least one threshold value for identifying link attributes between the plurality of elements in accordance with the relevance and the given first relationship data;
determining link types between the plurality of elements in accordance with the at least one threshold value; and
performing clustering to group one or more cluster sets of the plurality of elements in accordance with a result of determination.

2. The storage medium according to claim 1, wherein the first relationship data is given between each pair of elements in the first set of elements, the process further comprising:
providing second relationship data between at least two of the elements based on the given first relationship data between some of the elements.

3. The storage medium according to claim 2, wherein the performing clustering comprises:
clustering the plurality of elements so that at least one pair of elements in each of the cluster sets has the first relationship data in between, and at least one pair of elements in the each cluster set has the second relationship data in between.

4. The storage medium according to claim 1, wherein the calculating relevance comprises:
calculating as first relevance a similarity between elements that have the given first relationship data; and
calculating as second relevance a similarity between elements that have the provided second relationship data.

5. The storage medium according to claim 4, wherein the calculating at least one threshold value comprises:
setting a first threshold value as the calculated first relevance for determining the first relationship data; and
setting a second threshold value to be lower than the calculated first relevance but not lower than the calculated second relevance for determining the second relationship data.

6. The storage medium according to claim 5, wherein the determining link types between the plurality of elements comprises:
calculating a similarity between target elements in the plurality of elements;
comparing the calculated similarity between the target elements with the first threshold value and the second threshold value to estimate the calculated similarity between the target elements as the first relationship data or the second relationship data.

7. The storage medium according to claim 3, wherein each of the target elements in the plurality of elements is a document, and calculating the similarity between the target elements includes calculating a similarity between morphemes included in the documents.

8. A clustering method performed by a computer for clustering, the method comprising:
calculating relevance between a plurality of elements that first relationship data are given between a part of the plurality of elements, by using attributes of the plurality of elements;
calculating a threshold value for identifying link attributes between the plurality of elements in accordance with the relevance and the given relationship data;
determining link types between the plurality of elements in accordance with the threshold value; and
performing clustering to group one or more cluster sets of the plurality of elements in accordance with a result of determination.

9. The clustering method of claim 8, wherein the plurality of elements are a plurality of documents, and the method further comprises:
determining that each of the cluster sets of the elements represent documents having a particular point of view.

10. A clustering apparatus for clustering, the apparatus comprising:
a memory, and
a processor coupled to the memory and configured to:
calculate relevance between a plurality of elements that first relationship data are given between a part of the plurality of elements, by using attributes of the plurality of elements;
calculate a threshold value for identifying link attributes between the plurality of elements in accordance with the relevance and the given the relationship data;
determine link types between the plurality of elements in accordance with the threshold value; and
perform clustering to group one or more cluster sets of the plurality of elements in accordance with a result of determination.

11. A method for clustering a plurality of target documents, comprising:
extracting learning data from database, the learning data including learning documents and first relationship data given to identify a first relationship between some of the learning documents;
extracting, based on the given first relationship data, second relationship data from the learning data to identify a second relationship between some of the learning documents;
calculating a first similarity between the some documents having the first relationship identified by the first relationship data;
calculating a second similarity between the some documents having the second relationship identified by the second relationship data;
setting thresholds for similarity of documents based on the calculated first similarity and the calculated second similarity;
calculating a third similarity between the plurality of target documents;
estimating a relationship between the plurality of target documents by comparing the calculated third similarity between the plurality of target documents with the set thresholds; and
clustering the plurality of target documents into one or more cluster sets of target documents, each cluster set representing documents having a common topic.
